(19) United States
(12) Patent Application Publication
(10) Pub. No.: US 2021/0031736 A1
(43) Pub. Date: Feb. 4, 2021

(54) WHEEL CHOCK APPARATUS

(71) Applicant: Mark Perozzo, Payallup, WA (US)

(72) Inventor: Mark Perozzo, Payallup, WA (US)

(21) Appl. No.: 16/524,472

(22) Filed: Jul. 29, 2019

(51) Int. Cl. B60T 3/00

(52) U.S. Cl. CPC B60T 3/00

(57) ABSTRACT

Wheel chock apparatus including a plurality of wedge members configured to be positioned adjacent to a wheel. Each wedge member comprises a first end and a second opposite end, where a first flexible member is configured to attach to the first ends of each of the plurality of wedge members and a second flexible member is configured to attached to the second opposite ends of each of the plurality of wedge members. The first and second flexible members are configured to adjust a relative distance between the plurality of wedge members. In some examples, the wheel chock apparatus includes a chain and a tightening strap for adjusting the relative distance. In some further examples, the wheel chock apparatus includes locking mechanisms to prevent theft of the machine attached to the wheel and the wheel chock apparatus itself.

### BACKGROUND

The present disclosure relates generally to wheel chock apparatus. In particular, wheel chock apparatus for securing a single tire in a stationary position are described.

Known wheel chock apparatus are not entirely satisfactory for the range of applications in which they are employed. For example, many existing wheel chock apparatus do not provide flexible connectors to secure the chocks, nor two flexible connectors connected to either side of the chocks to wrap around the tire providing superior stabilization once the flexible connectors are pulled taught, as well as security from theft. In addition, conventional wheel chock apparatus do not provide adequate immobilization on uneven surfaces.

Thus, there exists a need for wheel chock apparatus that improve upon and advance the design of known wheel immobilization systems. Examples of new and useful wheel chock apparatus relevant to the needs existing in the field are discussed below.

### SUMMARY

The present disclosure is directed to wheel chock apparatus with a plurality of wedge members configured to be positioned adjacent to a wheel. Each wedge member comprises a first end and a second opposite end, where a first flexible member is configured to attach to the first ends of each of the plurality of wedge members and a second flexible member is configured to attached to the second opposite ends of each of the plurality of wedge members. The first and second flexible members are configured to adjust a relative distance between the plurality of wedge members which tightens and holds the plurality of wedge members against the wheel and immobilizes the wheel chock apparatus. In some examples, the wheel chock apparatus includes a chain and a tightening strap for adjusting the relative distance and creating tension for immobilization. In some further examples, the wheel chock apparatus includes one or more locking mechanisms to prevent theft of the machine attached to the wheel and the wheel chock apparatus itself.

### BRIEF DESCRIPTION OF THE DRAWINGS

FIG. 1 is a perspective view of a first example of a wheel chock apparatus.

FIG. 2 is side elevation view of the wheel chock apparatus shown in FIG. 1 depicting the location of the wheel chock bolts.

FIG. 3A is a perspective view of a second example of a wheel chock apparatus including a chain flexible member in an unlatched state.

FIG. 3B is a perspective view of the wheel chock apparatus shown in FIG. 3A depicting the chain flexible member in a latched state.

FIG. 4A is a perspective view of the wheel chock apparatus shown in FIG. 3A depicting a tightening flexible member in an unlatched state.

FIG. 4B is a perspective view of the wheel chock apparatus shown in FIG. 3A depicting the tightening flexible member in a latched state.

FIG. 5A is a perspective view of a third example of a wheel chock apparatus including a locking mechanism for a first flexible member attached to the wedge members.

FIG. 5B is a perspective view of the wheel chock apparatus shown in FIG. 5A including a locking mechanism for a second flexible member attached to the wedge members.

FIG. 6 is a perspective view of a fourth example of a wheel chock apparatus including a wheel on an uneven surface.

FIG. 7 is a perspective view of a fifth example of a wheel chock apparatus including a leveler under a wheel.

### DETAILED DESCRIPTION

The disclosed wheel chock apparatus will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity; each and every contemplated variation is not individually described in the following detailed description.

Throughout the following detailed description, examples of various wheel chock apparatus are provided. Related features in the examples may be identical, similar, or dissimilar different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

Conventional wheel chock devices are limited in their ability to provide a flexible means of securing and immobilizing an entire wheel of a machine, such as a trailer or vehicle. Additionally, conventional wheel chock devices may lack applications for use on uneven surfaces. Implementations of the present disclosure address the above-mentioned deficiencies and other deficiencies by apparatus to facilitate secure stabilization of the not only the wheel but the entire vehicle, trailer, etc. attached to the wheel. In one embodiment, a wheel chock apparatus comprises one or more flexible members are attached to two wheel chocks to be adjusted to secure entirely around the wheel, wherein the flexible members are tightened to create tension which immobilizes the entire wheel chock apparatus and the wheel until the tension is removed. When using the wheel chock apparatus on the wheels of a vehicle, trailer, etc., the immobilization of the wheels provides additional stabilization of the vehicle, trailer etc. This provides additional benefits, such as avoiding damage caused by a trailer tongue swinging into a vehicle. The entire trailer is essentially immobilized by the present wheel chock apparatus and thus provides a safer way to back a vehicle toward the trailer because the trailer is immobilized. In another example, a camper parked at a campsite where ground is not level may require leveling devices to level the camper. By immobilizing the wheels using the present wheel chock apparatus, the camper will not only not move forward or backward, but the camper also less likely to move side to side and thus damage the leveling devices.

In another embodiment, the flexible members may be a chain and a tightening strap, wherein the tightening strap provides the tension in the flexible members to immobilize the wheel chock apparatus and in turn, the vehicle, trailer, etc. attached to the wheel. In yet another embodiment, locking members may be added to the flexible members for additional wheel and apparatus security.

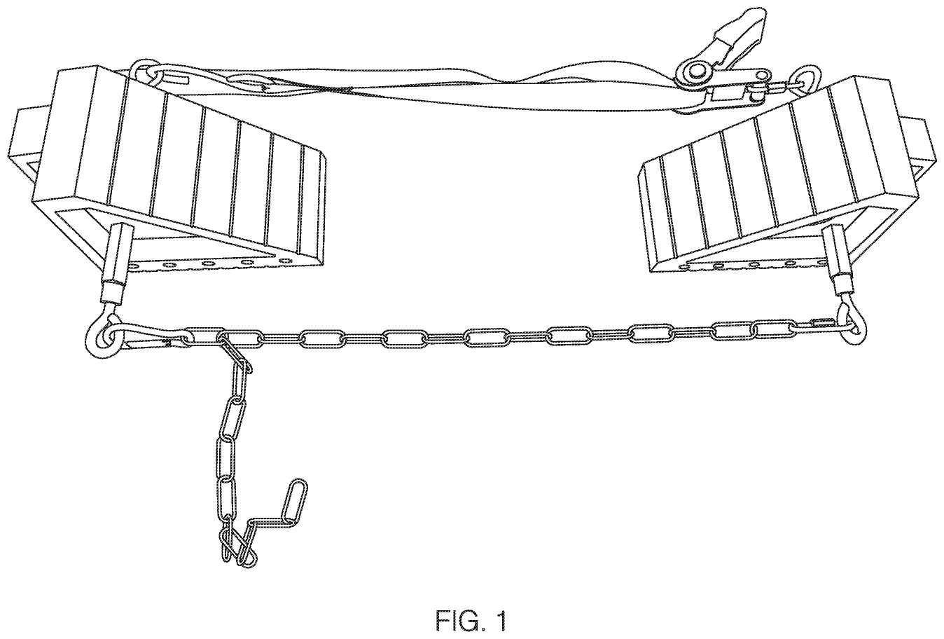

FIG. 1 illustrates a wheel chock apparatus 100, according to an embodiment. The wheel chock apparatus 100 includes a first wedge member 110 and second wedge member 120 for engaging with and securing a wheel (not shown). In one embodiment, the wheel may be attached to a vehicle, such as an automobile, a recreational vehicle, or an airplane. In another embodiment, the wheel may be attached to a trailer for a boat or snowmobile. Attached on opposite sides of the first wedge member 110 are attachment members 150, 155. Similarly, attached on opposite sides of the second wedge member 120 are attachment members 160, 165. Attachment members 150 and 160 allow for flexible member 130 to attach to the first wedge member 110 and the second wedge member 120. Similarly, attachment members 155 and 165 allow for flexible member 140 to attach to the first wedge member 110 and the second wedge member 120.

The attachment members 150, 155 and 160, 165 may vary and are not intended to be limiting. In one example, attachment members 150, 155, 160, 165 are eye bolts attached to the first and second wedge members, 110, 120 to provide attachment points for the flexible members 130, 140. In another embodiment, the attachment members 150, 155 is a single bolt and 160, 165 is a single bolt. The bolts traverse through the first and second wedge members 110, 120 and contain connectors on each end for engagement with flexible members 130, 140. The bolts may be adjustable to accommodate larger wheels. In another embodiment, the attachment members 150, 155 and 160, 165 are an existing part of the first and second wedge members, 110, 120. In yet another embodiment, attachment members 150, 155, 160, 165 may be located at different positions on the first and second wedge members 110, 120 to provide alternate points of tension to tighten and hold the first and second wedge members 110, 120 against the wheel. In a further embodiment additional attachment members (not shown) may be located on the first and second wedge members 110, 120 to provide additional points of tension to tighten and hold the first and second wedge members 110, 120 against the wheel.

The flexible members 130, 140 for adjustment of their lengths to shorten the distance between the first and second wedge members 110, 120 and ultimately tighten and hold the first and second wedge members 110, 120 against the wheel. The flexible members 130, 140 may be a cable, chain, strap, or other similar devices for adjusting the distance between the first and second wedge members 110, 120. The wheel chock apparatus 100 contains two flexible members 130, 140, one on each side of the wheel, to allow for improved securing of the wheel and in turn, the vehicle or trailer attached to the wheel. In other examples, the wheel chock apparatus includes additional or alternative features, such as a chain for the first flexible member, a tightening strap for the second flexible member, and a locking mechanism for the first flexible member, the second flexible member, or both.

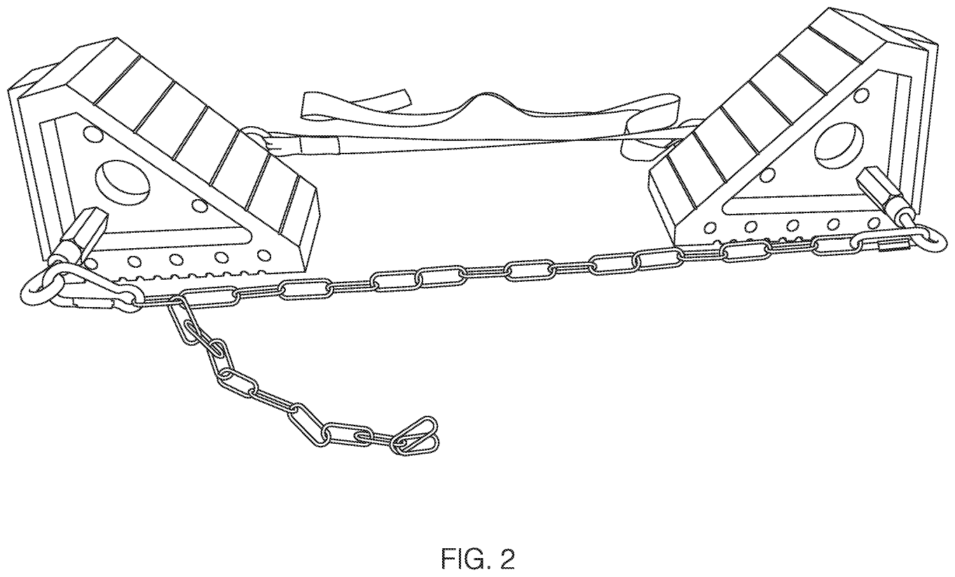

FIG. 2 illustrates a side perspective view of the wheel chock apparatus of FIG. with a detailed view of first wedge member 210 and second we member 220, according to an embodiment. The first and second wedge members 210, 220 may vary and are not intended to be limiting. For example, the first and second wedge members 210, 220 may each have multiple vertical treads 290 to prevent slippage against a wheel (not shown). In one embodiment, the first and second wedge members 210, 220 may have a flat inclined engaging surface 270, 280 that engages with the wheel. In another embodiment, the inclined engaging surfaces 270, 280 are curved to match or approximate the curvature of the wheel.

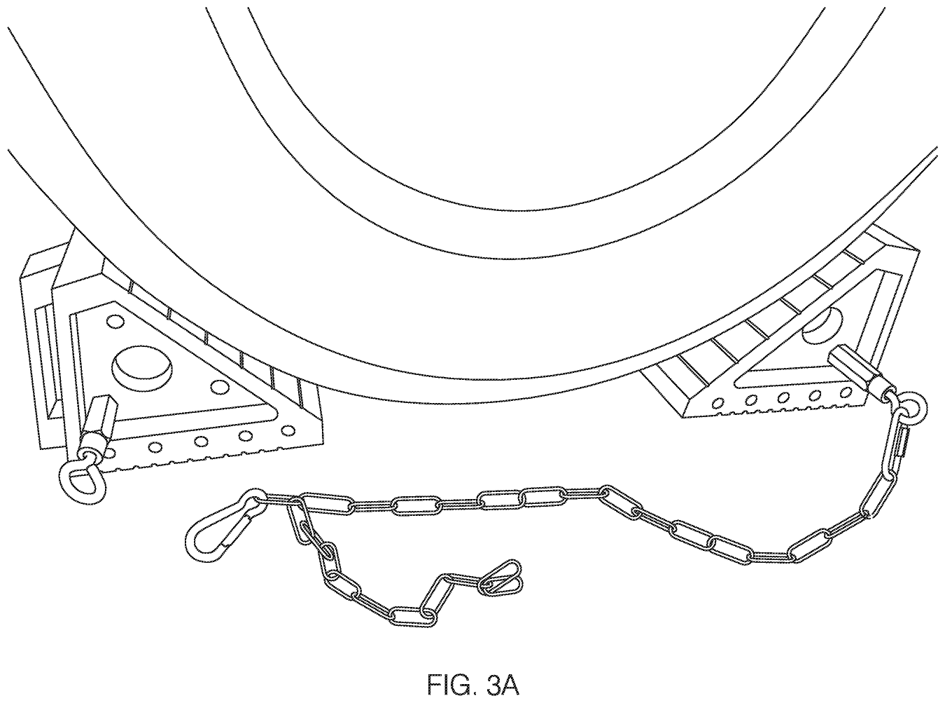

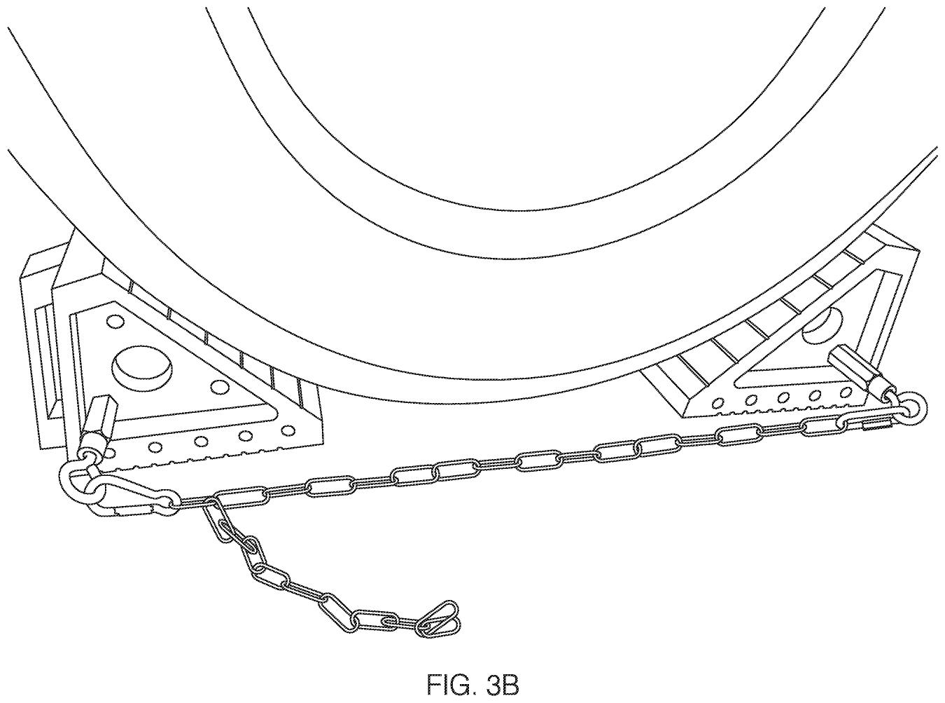

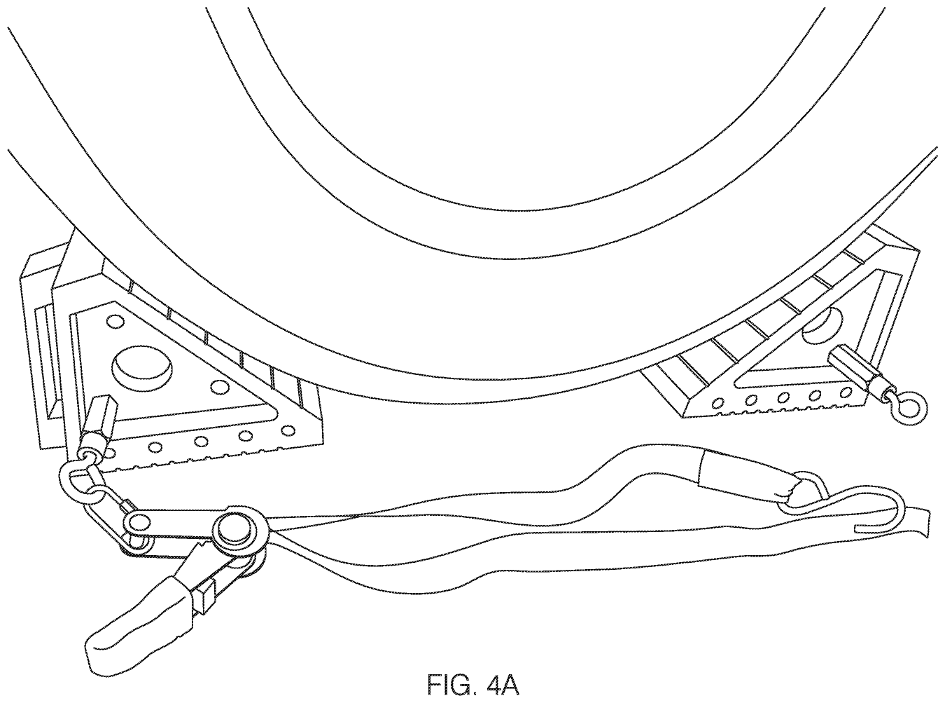

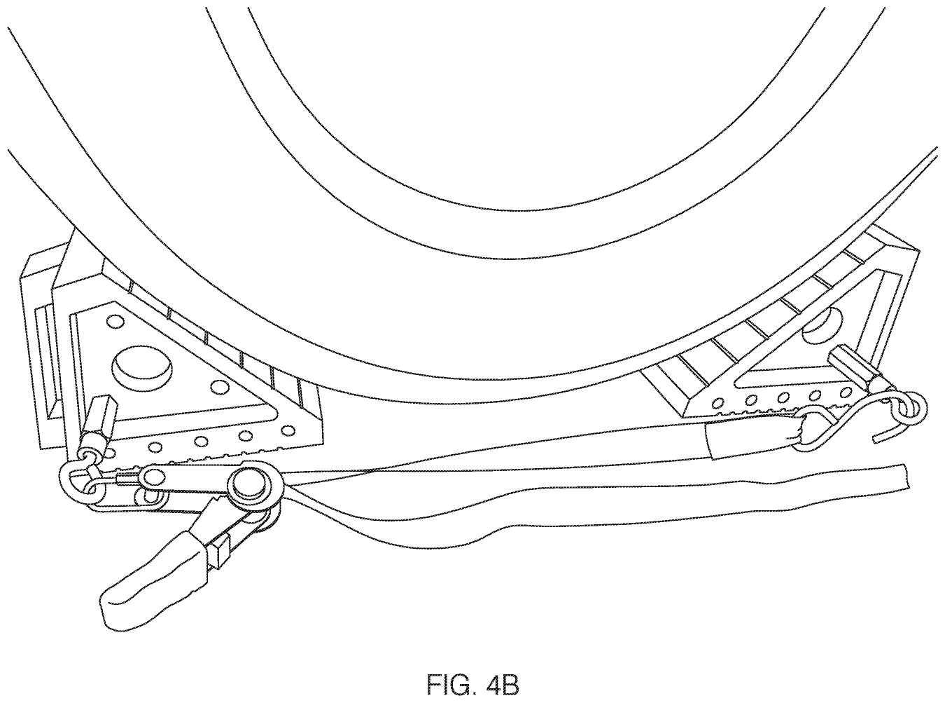

Turning attention to FIGS. 3A-B and 4A-B, another embodiment of a wheel chock apparatus will now be described. Wheel chock apparatus 300 of FIG A-B and wheel chock apparatus 400 of FIGS. 4A-B includes many similar or identical features to wheel chock apparatus 100. Thus, for the sake of each feature of wheel chock apparatus 300, 400 will not be redundantly explained. Rather, key distinctions between wheel chock apparatus 300, 400 and wheel chock apparatus 100 will be described in detail and the reader should reference the discussion above for features substantially similar between the three wheel chock apparatus.

As can be seen in FIG. 3A, wheel chock apparatus 300 includes first wedge member 320, second wedge member 330, flexible member 340, and attachment members 370, 380. For illustrative purposes, a wheel 310 is shown engaged with the wheel chock apparatus 300. In one embodiment, flexible member 340 is a chain with multiple links for adjusting to the size of the wheel 310. The flexible member 340 has a detachable connector 350 to engage with attachment member 370 and a fixed connector 360 attached to attachment member 380. The fixed connector 380 may be permanently attached to attachment member 380. In another embodiment, the detachable connector 350 is connected to attachment member 380 and the fixed connector 360 is connected to attachment member 370.

FIG. 3B illustrates the full engagement of the wheel chock apparatus 300 with the wheel 310. In one embodiment, the first and second wedge members 320, 330 are placed against the wheel 310 and the flexible member 340 is connected to the second wedge member 330 via the attachment member 380 and the fixed connector 360. The distance between the first and second wedge members 320, 330 is adjusted by adjusting the length of the flexible member 340 alongside the wheel 310. Once the desired length is achieved in order to tightly secure the first and second wedge members 320, 330 against the wheel 310, the detachable connector 350 is then connected to attachment member 370. In one embodiment, the flexible member 340 is a chain and the detachable connector 350 is a carabiner. The chain is pulled taught alongside the wheel 310 and the carabiner is then connected to the attachment member 370 to maintain the tension on the chain.

FIG. A illustrates the opposite side of the wheel chock apparatus 300 shown in. FIGS. 3A-B. In one embodiment, wheel chock apparatus 400 includes first wedge member 420, second wedge member 430, flexible member 440, and attachment members 470, 480. For illustrative purposes, a wheel 410 is shown engaged with the wheel chock apparatus 400. In one embodiment, flexible member 440 is a strap with a tightening mechanism 445 for adjusting to the size of the wheel 410 and tightening the flexible member to provide tension to and immobilization of the entire wheel chock apparatus 400. The tightening mechanism 445 as shown is a ratcheting device, however other tightening mechanisms may be used, such as a turnbuckle. The flexible member 440 has a fixed connector 460 attached to attachment member 480 and a detachable connector 450 to engage with attachment member 470. The fixed connector 460 may be permanently attached to attachment member 480. In another embodiment, the detachable connector 450 is connected to attachment member 480 and the fixed connector 460 is connected to attachment member 470.

FIG. 4B illustrates the full engagement of the wheel chock apparatus 400 with the wheel 410. In one embodiment, the first and second wedge members 420, 430 are placed against the wheel 410 and the flexible member 440 is connected to the second wedge member 430 via the attachment member 480 and the fixed connector 460. The distance between the first and second wedge members 420, 430 is adjusted by adjusting the length of the flexible member 440 alongside the wheel 410. In one embodiment, the flexible member 440 is a strap with a tightening mechanism 445, such as a ratcheting device, as shown, or a turnbuckle, and the detachable connector 450 is a hook. Once the detachable connector 450 is connected to attachment member 470, the tightening mechanism 445 is engaged until the strap is pulled taught alongside the wheel 410 such that the first and second wedge members are held taught against the wheel and the entire wheel chock apparatus 400 is immobilized, which that no part of the wheel chock apparatus 400 can be moved until the tension in the flexible member 440 is released by the tightening mechanism 445.

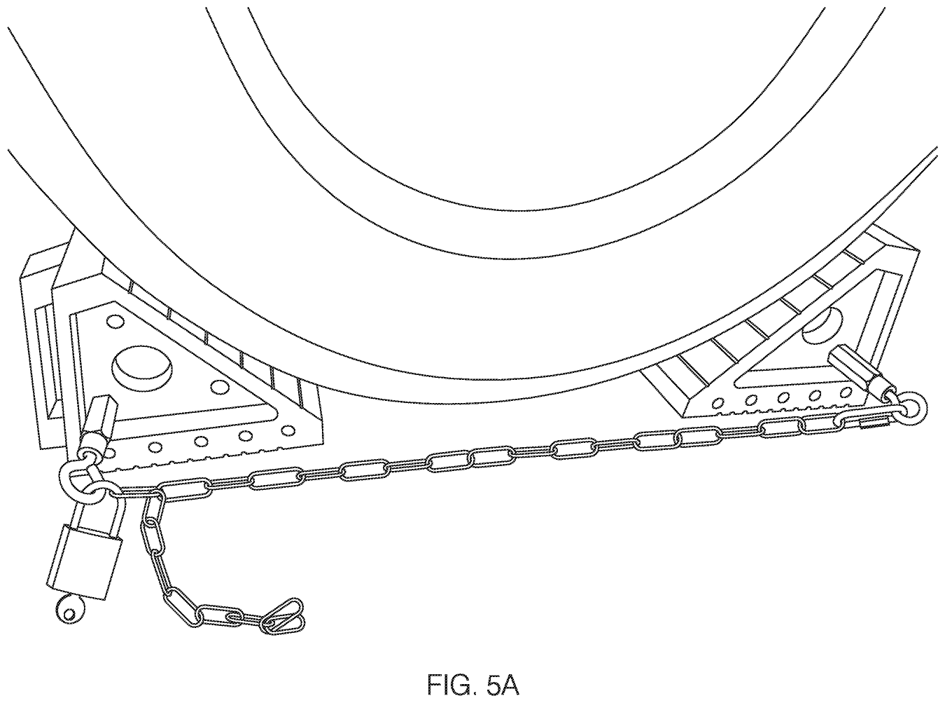

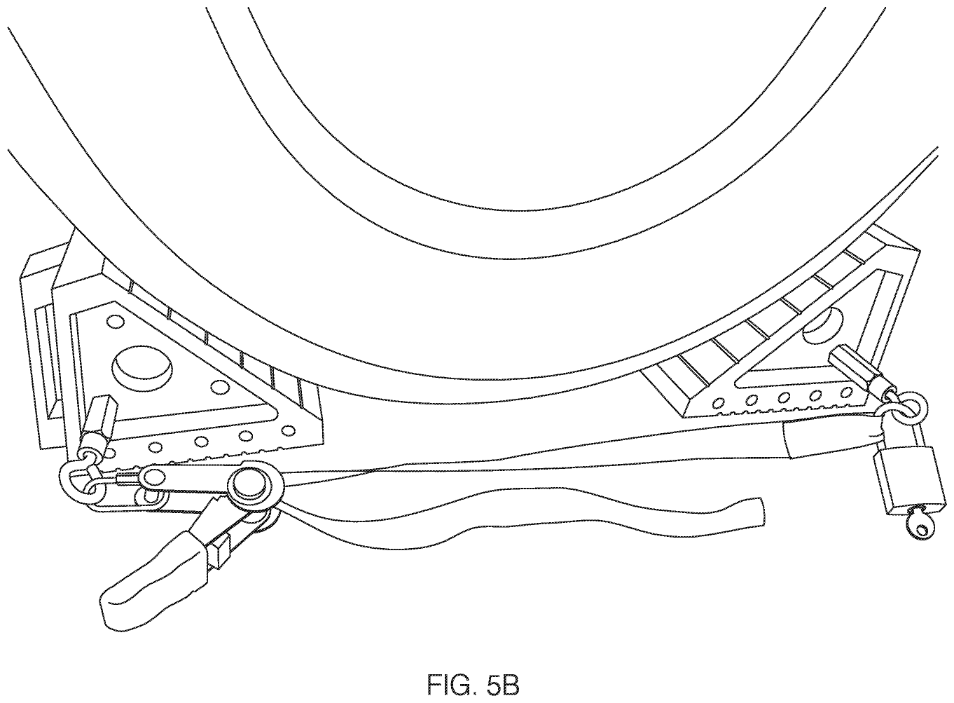

Turning attention to FIGS. 5A and 5B, wheel chock apparatus 500 will now be described. Wheel chock apparatus 500 of FIGS. 5A and 5B includes many similar or identical features to wheel chock apparatus 100. Thus, for the sake of brevity, each feature of wheel chock apparatus 500 will not be redundantly explained. Rather, key distinctions between wheel chock apparatus 500 and wheel chock apparatus 100 will be described in detail and the reader should reference the discussion above for features substantially similar between the two wheel chock apparatus.

As can be seen in FIG. 5A, wheel chock apparatus 500 includes a first locking mechanism 550 and a corresponding first key 555. In one embodiment, first and second wedge members 520, 525 are placed against wheel 510 and first flexible member 540 is connected to the second wedge member 525 via attachment member 535 and first fixed connector 545. The distance between the first and second wedge members 520, 525 is adjusted by adjusting the length of a first flexible member 540 alongside the wheel 510. Once the desired length is achieved in order to secure the first and second wedge members 520, 525 against the wheel 510, the first locking mechanism 550 is then connected to attachment member 530. In one embodiment, the first flexible member 540 is a chain where chain is pulled taught alongside the wheel 510 and the first locking mechanism. 550 is then connected to the chain and the attachment member 530 to maintain the tension on the chain. The first key 555 is inserted into the first locking mechanism 550 to engage the lock and then removed to prevent theft of the heel chock assembly 500. In other embodiments, the first locking mechanism 550 may not require the first key 555 and instead may be a different type of lock, including, but not limited to, a combination lock.

FIG. 5B illustrates the opposite side of the wheel chock apparatus 500 of FIG. 5A. In one embodiment, the first and second wedge members 520, 525 are placed against the wheel 510 and a second flexible member 570 is connected to the second wedge member 525 via attachment member 565 and a second fixed connector 580. A second locking mechanism 590 is then connected to attachment member 560 to prevent theft. The distance between the first and second wedge members 520, 525 is adjusted by adjusting the length of the second flexible member 570 alongside the wheel 510. In one embodiment, the first flexible member 540, as illustrated in FIG. 5A, is secured first before the second flexible member 570 is secured, as illustrated in FIG. 5B.

In one embodiment, the first flexible member 570 is a strap with a tightening mechanism 575 and the second locking mechanism 590 contains a corresponding second key 595. The second locking mechanism 550 is connected to the second flexible member 570 and attachment member 565 and then the tightening mechanism 575 is engaged until the strap is pulled taught alongside the wheel 510 such that the entire wheel chock apparatus 500 is immobilized and no part of the wheel chock apparatus 500 can be moved until the tension in the tightening mechanism 575 is removed. The second key 595 is inserted into the locking mechanism 590 to engage the lock and them removed prevent theft of the wheel chock assembly 500. In other embodiments, the locking mechanism 590 may not require the second key 595 and instead may be a different type of lock, including, but not limited to, a combination lock. In another embodiment, the first flexible member 540 is secured first before the second flexible member 570 is secured. In an alternative embodiment, the tightening mechanism 575 includes a lock (not shown) to prevent theft.

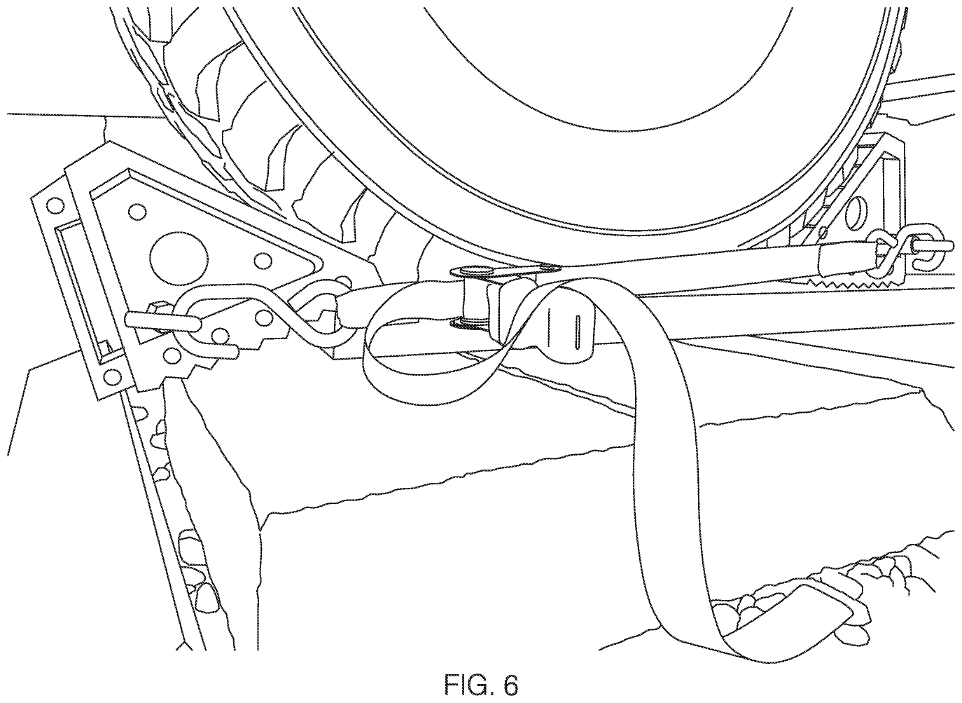

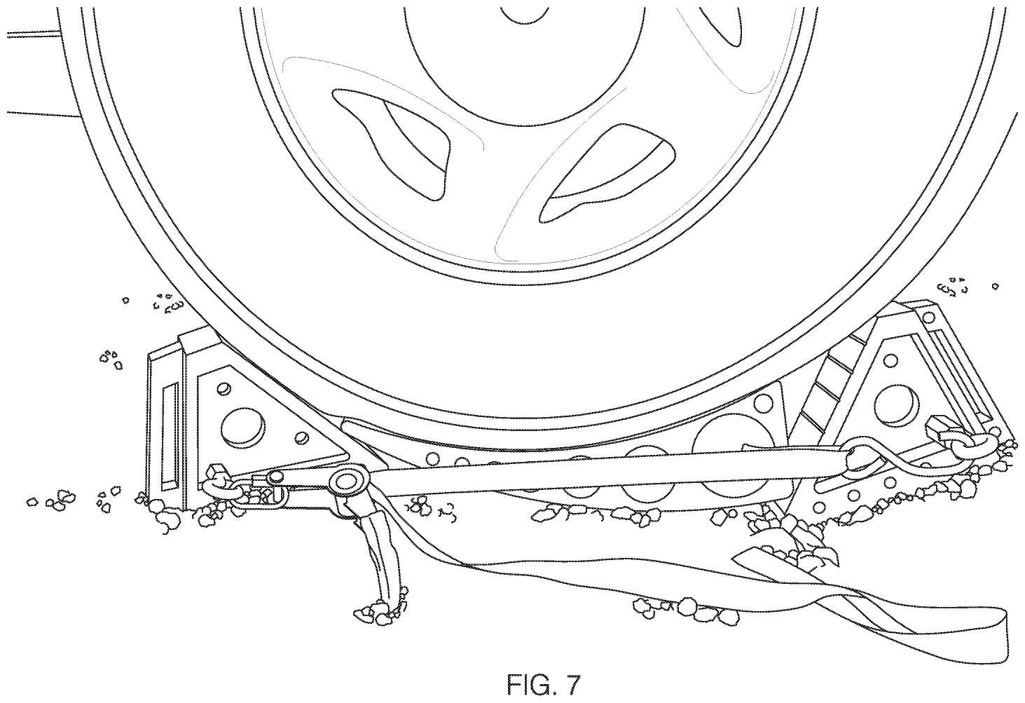

Turning attention to FIGS. 6 and 7, w heel chock apparatus 600 and 700 will now be described for situations where the surface upon which the wheel chock apparatus 600 and 700 will be used is not level and/or uneven. Wheel chock apparatus 600 and 700 of FIGS. 6 and 7 includes many similar or identical features to wheel chock apparatus 100. Thus, for the sake of brevity, each feature of wheel chock apparatus 600 and 700 will not be redundantly explained. Rather, key distinctions between wheel chock apparatus 600 and 700 and wheel chock apparatus 100 will be described in detail and the reader should reference the discussion above for features substantially similar between the two wheel chock apparatus.

FIG. 6 illustrates a wheel chock apparatus 600 implemented on an uneven surface. In one embodiment, a vehicle, trailer, or other wheeled-device may need to be secured on a surface that is uneven. For example, a trailer may need to be parked and secured on cider blocks. As shown in FIG. 6, wheel chock apparatus 600 is similar to wheel chock apparatus 400 of FIG. 4B with first and second wedge members 620, 630 and a flexible member 640. The wheel chock apparatus 600 may be implemented by way of any of the above-described embodiments with the exception that wedge member 630 will not be flush against the wheel 610. This modification still secures the wheel 610 and immobilizes the wheel chock apparatus 600 once the wheel chock apparatus 600 is fully implemented.

FIG. 7 illustrates a wheel chock apparatus 700 with a leveler 750 underneath a wheel 710. In one embodiment, a vehicle, trailer, or other wheeled-device may need to be secured on a surface that is not level. For example, a recreational vehicle (RV) may need to park in a campsite where the ground is sloped. To level the RV (not shown), the wheel 710 of the RV is driven, pulled, pushed or otherwise moved onto the leveler 750. Once the RV is level, the wheel chock apparatus 700 may be applied. As shown in FIG. 7, wheel chock apparatus 700 is similar to wheel chock apparatus 400 of FIG. 4B with first and second wedge members 720, 730 and a flexible member 740. The wheel chock apparatus 700 may be implemented by way of any of the above-described embodiments.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element,“a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims the present application or in a related application. Such amended or new claims, whether they are directed to the same invention or a different invention and whether they are different, broader, narrower or equal in scope to the original claims, are to be considered within the subject matter of the inventions described herein.

1. A wheel chock apparatus, comprising:
a plurality of wedge members, wherein the plurality of wedge members are configured to be positioned adjacent to a wheel, and each wedge member comprising a first end and a second opposite end;
a first flexible member configured to attach to the first ends of each of the plurality of wedge members;
a second flexible member configured to attached to the second opposite ends of each of the plurality of wedge members,
wherein the first and second flexible members are further configured to adjust a relative distance between the plurality of wedge members such that tension is created in the wheel chock apparatus as to immobilize the wheel and the wheel chock apparatus, and
wherein removal of the wheel chock apparatus from the wheel is achieved only by releasing the tension.

2. The first flexible member of claim 1, further comprising a free end removably attached to one of the first ends of the plurality of wedge members and a fixed end attached to the opposite of the first ends of the plurality of wedge members.

3. The second flexible member of claim 1, further comprising a free end removably attached to one of the second ends of the plurality of wedge members and a fixed end attached to the opposite of the second ends of the plurality of wedge members.

4. The first flexible member of claim 1, further comprising a chain.

5. The second flexible member of claim 1, further comprising a strap with a lightening member.

6. The apparatus of claim 5 wherein the first flexible member is configured to adjust the distance between the plurality of wedge members to secure the plurality of wedge members against the wheel prior o the second flexible member.

7. The apparatus of claim 6, wherein the second flexible member is configured to secure the plurality of wedge members against the wheel with the tightening member after the first flexible member secures the plurality of wedge members against the wheel.

8. The apparatus of claim 1, wherein the plurality of wedge members are configured to be positioned on radially opposite sides of the wheel.

9. The apparatus of claim 1, wherein the wheel is positioned on an uneven surface.

10. The apparatus of claim 1, wherein a leveler is placed underneath the wheel prior to the wedge members positioned adjacent to the wheels.

11. A wheel chock apparatus, comprising:
a plurality of wedge members, wherein the plurality of wedge members are configured to be positioned adjacent to a wheel, and each wedge member comprising a first end and a second opposite end;
a first flexible member comprising a chain, a free end, and a fixed end, wherein:
the free end of the first flexible member is configured to removably attach to the first end of a first wedge member, and
the fixed end of the first flexible member is configured to attach to the first end of a second wedge member;
a second flexible member comprising a strap with a tightening member, a free end, and a fixed end, wherein:
the free end of the second flexible member is configured to removably attach to the second opposite end of the first wedge member, and
the fixed end of the second flexible member is configured to attach to the second opposite end of the second wedge member;
wherein the chain of the first flexible member is configured to adjust distance between the plurality of wedge members to secure the plurality of wedge members against the wheel; and
wherein the tightening member of the second flexible member is configured to secure the plurality of wedge members against the wheel by creating tension sufficient to immobilize the wheel chock apparatus; and
wherein the wheel chock apparatus is removed from the wheel only by releasing the tension in the second flexible member with the tightening member.

12. The apparatus of claim 11, wherein the tightening member is one or more of a ratcheting device or turnbuckle.

13. The apparatus of claim 10, wherein the free end of the first flexible member is attached to a first end of a first wedge members and the free end of the second flexible member is attached to a second opposite end of the first wedge member.

14. The apparatus of claim 15, wherein the fixed end of the first flexible member is attached to a first end of a second wedge members and the fixed end of the second flexible member is attached to a second opposite end of the second wedge member.

15. The apparatus of claim 16, wherein the first wedge member is placed adjacent to the wheel prior to the second edge member.

16. A wheel chock apparatus, comprising:
a plurality of wedge members, wherein the plurality of wedge members are configured to be positioned adjacent to a wheel, and each wedge member comprising a first end and a second opposite end;
a first flexible member configured to attach to the first ends of each of the plurality of wedge members, wherein the first flexible member has a free end removably attached to one of the first ends of the plurality of wedge members; and
a second flexible member configured to attach to the second opposite ends of each of the plurality of wedge members wherein the second flexible member has a free end removably attached to one of the second ends of the plurality of wedge members with a first locking member,
wherein the first and second flexible members are further configured to adjust a relative distance between the plurality of wedge members such that tension is created in the wheel chock apparatus as to immobilize the wheel and the wheel chock apparatus and secured with the first locking member, and
wherein removal of the wheel chock apparatus from the wheel is achieved only by releasing the tension and removal of the first locking member.

17. The apparatus of claim 16, wherein the first flexible member has a free end removably attached to one of the first ends of the plurality of wedge members a second locking member.

18. The apparatus of claim 17, wherein removal of the wheel chock apparatus is achieved only by releasing the tension and removal of the first locking member and the second locking member.

19. The apparatus of claim 16, wherein the second flexible member includes a tightening member to create the tension in the wheel chock apparatus, and wherein the tightening member includes a third locking member.

20. The apparatus of claim 16, wherein:
the first flexible member has a fixed end attached to the opposite of the first ends of the plurality of wedge members, and
the second flexible member has a fixed end attached to the opposite of the second ends of the plurality of wedge members.
